(19) United States
(12) Patent Application Publication
(10) Pub. No.: US 2011/0017457 A1
(43) Pub. Date: Jan. 27, 2011

(54) ENVIRONMENTAL COMPOSITIONS AND METHODS FOR WELL TREATMENT

(76) Inventors: Mathew M. Samuel, Sugar Land, TX (US); Anthony F. Veneruso, Sugar Land, TX (US); Michael Tempel, New York, NY (US); Lijun Lin, Sugar Land, TX (US); Leiming Li, Sugar Land, TX (US)

Correspondence Address: SCHLUMBERGER TECHNOLOGY CORPORATION;David Cate, IP DEPT., WELL STIMULATION, 110 SCHLUMBERGER DRIVE, MD1, SUGAR LAND, TX, 77478, US

(21) Appl. No.: 12/833,162

(22) Filed: Jul. 9, 2010

Related U.S. Application Data
(60) Provisional application No. 61/227,281, filed on Jul. 21, 2009.
(60) Provisional application No. 61/227,265, filed on Jul. 21, 2009.

(51) Int. Cl. E21B 43/16; C09K 8/62

(52) U.S. Cl. 166/305.1; 507/204

(57) ABSTRACT

The invention provides a well treatment composition comprising: a viscoelastic surfactant or a cementing composition and an environmentally friendly component made of cellulosic matrix with organic acid trapped within. A method is disclosed comprising introducing into a wellbore penetrating a subterranean formation an environmentally friendly component made of cellulosic matrix with organic acid trapped within.

Also, the invention provides a method for rheology modification optimization of a viscoelastic surfactant, comprising: (a) defining a rheology profile of the viscoelastic surfactant; (b) defining a comparative rheology profile of a composition of the viscoelastic surfactant and a first environmentally friendly naturally occurring component made of cellulosic matrix with organic acid derivative trapped within; (c) repeating step (b) with a second environmentally friendly component made of cellulosic matrix with organic acid derivative trapped within; (d) defining between the first and second environmentally friendly components, environmentally friendly component showing optimum modification of the rheology based on analysis of the rheology profile and comparative rheology profile.

### CROSS-REFERENCE TO RELATED APPLICATIONS

This application claims the benefit of U.S. Provisional Application No. 61/227,281, filed Jul. 21, 2009 and of U.S. Provisional Application No. 61/227,265, filed Jul. 21, 2009, which are both incorporated herein by reference in theirs entireties.

### FIELD OF THE INVENTION

This invention relates generally to composition and method for treating a well penetrating a subterranean formation. More specifically, the invention relates to environmentally friendly composition and method to use the composition in well treating operations.

### BACKGROUND

Some statements may merely provide background information related to the present disclosure and may not constitute prior art.

Hydraulic fracturing of subterranean formations has long been established as an effective means to stimulate the production of hydrocarbon fluids from a wellbore. In hydraulic fracturing, a well stimulation fluid (generally referred to as a fracturing fluid) is injected into and through a wellbore and against the surface of a subterranean formation penetrated by the wellbore at a pressure at least sufficient to create a fracture in the formation. Usually a “pad fluid” is injected first to create the fracture and then a fracturing fluid, often bearing granular propping agents, is injected at a pressure and rate sufficient to extend the fracture from the wellbore deeper into the formation. If a proppant is employed, the goal is generally to create a proppant filled zone from the tip of the fracture back to the wellbore. In any event, the hydraulically induced fracture is more permeable than the formation and it acts as a pathway or conduit for the hydrocarbon fluids in the formation to flow to the wellbore and then to the surface where they are collected.

Viscoelastic surfactant fluids are normally included in the carrier fluid in order to facilitate the transport of the granular propping agents into the fracture. Typically, viscoelastic surfactant fluids are made by mixing into the carrier fluid appropriate amounts of suitable surfactants such as anionic, cationic, nonionic and zwitterionic surfactants. The viscosity of viscoelastic surfactant fluids is attributed to the three dimensional structure formed by the components in the fluids. When the concentration of viscoelastic surfactants significantly exceeds a critical concentration, surfactant molecules aggregate into micelles, which can become highly entangled to form a network exhibiting elastic behavior.

A key aspect of well treatment such as hydraulic fracturing is the “cleanup”, e.g., removing the carrier fluid from the fracture (i.e., the base fluid without the proppant) after the treatment has been completed. Techniques for promoting fracture cleanup often involve reducing or “breaking” the viscosity of the fracture fluid as much as practical so that it will more readily flow back toward the wellbore.

There are also many other applications in which breakers are needed to decrease the viscosity of treatment fluids, such as gravel packing, acidizing fluids, viscosified with polymers or crosslinked polymers or viscoelastic surfactants. Most commonly, these breakers act in fluids that are in gravel packs or fractures; some breakers can work in fluids in formation pores. Breakers decrease viscosity by degrading polymers or crosslinkers when the viscosifiers are polymers or crosslinked polymers. Breakers decrease viscosity by degrading surfactants or destroying micelles when viscosifiers are viscoelastic surfactant fluid systems. Most breakers are solids, for example granules or encapsulated materials, which do not enter the formation. As these soluble breakers dissolve completely in water on contact, their reaction to the polymer is not delayed and the viscosity and solids carrying capability of the fluid is dramatically lowered. To eliminate this, encapsulated breakers are used and they release the breaker only when crushed. There is sometimes a need to break viscous fluids within the pores of formations, for example when viscous fluids enter formations during fracturing, gravel packing, acidizing, matrix dissolution, lost circulation treatments, scale squeezes, and the like. Breakers that are effective inside formations will be called internal breakers here. These fluids that enter the formation may be main treatment fluids (such as fracturing fluids) or they may be secondary fluids (such as flushes or diversion fluids such as viscoelastic diverting acids). Typically it is necessary that the break be delayed, that is that the breaker not act until after the fluid has performed its function.

There are also many other applications in which components for modifying properties of treatment fluids, such as gravel packing, acidizing fluids, viscosified with polymers or crosslinked polymers or viscoelastic surfactants are needed. Said components have in common with the breakers the same property of modifying the surface tension of the treatment fluids and impacting the viscosity or other properties. Accordingly, the component may be a shear recovery agent, a defoamer, an antifoamer or any type of similar agent with similar properties.

Compositions and treatment methods using a breaker, a defoamer or other components that are environmentally friendly would be of value and useful for many applications requiring treatment fluids as described above. It would be desirable to have a number of such materials so that they could be used under different subterranean conditions, for example different temperatures and different formation fluid chemistries. Also, it would be desirable to have an optimization process together with a panel or portfolio of environmentally friendly raw materials to decide on the specific environmentally friendly material or on the mixture of environmentally friendly materials to use for enhanced breaking advantages of viscoelastic surfactant fluids or enhanced defoaming of fluids.

### SUMMARY

In a first aspect, a well treatment composition is disclosed. The composition comprises: a viscoelastic surfactant and an environmentally friendly component made of cellulosic matrix with organic acid derivative trapped within.

In a second aspect, a well treatment composition is disclosed. The composition comprises: a cementing composition and an environmentally friendly defoamer made of cellulosic matrix with organic acid derivative trapped within.

In a third aspect, a method is disclosed. The method comprises: introducing into a wellbore penetrating a subterranean formation an environmentally friendly component made of cellulosic matrix with organic acid derivative trapped within.

In a fourth aspect, a method for rheology modification optimization of a viscoelastic surfactant fluid is disclosed. The method comprises: (a) defining a rheology profile of the viscoelastic surfactant fluid; (b) defining a comparative rheology profile of a composition of the viscoelastic surfactant fluid and a first environmentally friendly component made of cellulosic matrix with organic acid derivative trapped within; (c) repeating step (b) with a second environmentally friendly component made of cellulosic matrix with organic acid derivative trapped within; (d) defining between the first and second environmentally friendly components, environmentally friendly component showing optimum modification of the rheology based on analysis of the rheology profile and comparative rheology profile.

In a fifth aspect, a method for rheology modification optimization of a viscoelastic surfactant is disclosed. The method comprises: (a) defining a rheology profile of the viscoelastic surfactant at a first given temperature; (b) defining a comparative rheology profile at the first given temperature of a composition of the viscoelastic surfactant and a first environmentally friendly component made of cellulosic matrix with organic acid derivative trapped within; (c) repeating step (b) with a second environmentally friendly component made of cellulosic matrix with organic acid derivative trapped within; (d) repeating steps (a) and (b) with a second given temperature and further step (c) with said second given temperature; and (e) defining between the first and second environmentally friendly components, environmentally friendly component showing optimum modification of the rheology based on analysis of the rheology profile and comparative rheology profile for the first and second temperatures.

In a sixth aspect, a method for defoaming optimization of a composition is disclosed. The method comprises: (a) defining a foaming property of the composition; (b) defining a comparative foaming property of the composition and a first environmentally friendly component made of cellulosic matrix with organic acid derivative trapped within; (c) repeating step (b) with a second environmentally friendly component made of cellulosic matrix with organic acid trapped within; (d) defining between the first and second environmentally friendly components, environmentally friendly component showing optimum defoaming property based on analysis of the foaming property and the comparative foaming property.

### BRIEF DESCRIPTION OF THE DRAWINGS

FIG. 1 shows viscosity profile as a function of time at 200° F. (93.3° C.) for a VES fluid containing 6 vol % BET-E-40, 2 wt % KCl and 1 wt % breaker candidate.

FIG. 2 shows viscosity profile as a function of time at 150° F. (65.6° C.) for a VES fluid containing 6 vol % BET-E-40, 2 wt % KCl, and 1 wt % breaker candidate

FIG. 3 shows viscosity profile as a function of time at 150° F. (65.6° C.) for a VES fluid containing 6 vol % BET-E-40, 2 wt % KCl, and 0.2 wt % breaker candidate.

FIG. 4 shows viscosity profile as a function of time for a VES fluid containing 6 vol % BET-E-40, 2 wt % KCl, and 1 wt % cinnamon at 200° F. (93.3° C.).

FIG. 5 shows viscosity profile as a function of time for a VES fluid containing 6 vol % BET-E-40, 2 wt % KCl, and 1 wt % cinnamon at 150° F. (65.6° C.)

FIG. 6 shows viscosity profile as a function of time for a VES fluid containing 6 vol % BET-E-40 and 0% or 2% coconut powder at 200° F. (93° C.) in CaCl₂ brine at 1.26 kg/L (10.5 ppg).

FIG. 7 shows foam height of various fluids with or without material according to the invention showing that in the presence of these materials, the formation of the foam can be suppressed/eliminated.

FIG. 8 shows foam half-life of various fluids with or without material according to the invention showing destabilization of a stable foam.

FIG. 9 shows an end of stage temperature tracking base on fracturing simulator software for a typical High-Temperature well showing cooling effects.

### DETAILED DESCRIPTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. The description and examples are presented solely for the purpose of illustrating the preferred embodiments of the invention and should not be construed as a limitation to the scope and applicability of the invention. While the compositions of the invention are described herein as comprising certain materials, it should be understood that the composition could optionally comprise two or more chemically different materials. In addition, the composition can also comprise some components other than the ones already cited.

In the summary of the invention and this description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific data points, it is to be understood that inventors appreciate and understand that any and all data points within the range are to be considered to have been specified, and that inventors have disclosed and enabled the entire range and all points within the range.

The following definitions are provided in order to aid those skilled in the art in understanding the detailed description of the invention.

The term “fracturing” refers to the process and methods of breaking down a geological formation and creating a fracture, i.e. the rock formation around a well bore, by pumping fluid at very high pressures, in order to increase production rates from a hydrocarbon reservoir. The fracturing methods otherwise use conventional techniques known in the art.

The term “surfactant” refers to a soluble or partially soluble compound that reduces the surface tension of liquids, or reduces inter-facial tension between two liquids, or a liquid and a solid by congregating and orienting itself at these interfaces.

The term “viscoelastic” refers to those viscous fluids having elastic properties, i.e., the liquid at least partially returns to its original form when an applied stress is released.

The phrase “viscoelastic surfactant” or “VES” refers to that class of compounds which can form micelles (spherulitic, anisometric, lamellar, or liquid crystal) in the presence of counter ions in aqueous solutions, thereby imparting viscosity to the fluid. Anisometric micelles can be used, as their behavior in solution most closely resembles that of a polymer.

A family of naturally occurring and environmentally friendly breakers or defoamers for treatment fluids are disclosed herewith. These materials have oils, lipids, fat and other carboxylic acid derivatives in them, and can release these into the viscous fluid to break it for example. Also, these environmentally safe products also produce better defoaming results in a time-temperature delayed manner. These self degrading materials can be used to suppress/eliminate the production of foams and also to break foam when required. These materials can be used in different forms such as powder, slurry, pellets, chunks and as a whole. These breakers/defoamers are produced from the above in the natural form, after drying, freeze-drying, rosting or similar preparations.

Generally, the materials are made of a cellulosic matrix with organic acid derivative or derivatives trapped within. The cellulosic matrix may contain cellulose, starch and other sugar derivatives. By way of examples, the material can be: coconut, mustard, nutmeg, peanut, sesame, canola, cashew nut, corn, neetsfoot, almond, cottonseed, palm, walnut, caster seed, perilla, beech nut, lard, rice bran, pistachios, linseed, sunflower seed, hazelnut, squash seed, safflower, kola nut, rapeseed, sardine, brazilnut, candlenut, chili seed, chestnut, acorn, soybean, macademia, coco, coffee bean, pinenut, butternut, pumpkin, hickory, dees nuts, olive, filbert, pecan, cacao, garlic powder, ginger, cinnamon.

Depending of the variety or nature of the material taken, the amount of organic acid derivative trapped within the cellulosic matrix may vary. As well, depending on the form (natural form, after drying, freeze-drying, rosting) or treatment/preparation of the material, ability/time of the organic acid derivative to be released from the cellulosic matrix may vary. As well, depending on the environmental parameters of the material (pH, temperature, salinity, etc. . . . ), ability/time of the organic acid derivative to be released from the cellulosic matrix may vary.

By combining these factors, a process of optimization according to the invention is disclosed. For the material used as breaker, the process comprises: defining a rheology profile of the viscoelastic surfactant; defining a comparative rheology profile of a composition of the viscoelastic surfactant and a first environmentally friendly component; repeating previous step with a second environmentally friendly component, and defining between the first and second environmentally friendly components, environmentally friendly component showing optimum modification of the rheology based on analysis of the rheology profile and comparative rheology profile.

The steps can be repeated for environmentally friendly components varying between first environmentally friendly component to n-th environmentally friendly component, and defining between the first to n-th environmentally friendly components, environmentally friendly component showing optimum modification of the rheology based on analysis of the rheology profile and comparative rheology profiles.

In this way, if a specific application is sought, it is possible for a panel of available environmentally friendly materials to find this one which will be the most suited. The specific application can be defined by various needed criteria. The criteria to look to choose the environmentally friendly material can be time to break of the viscoelastic surfactant, amount of decrease of the rheology, pH activity, temperature stability, salinity concentration, etc. . . . . Environmentally friendly material best suiting one or several of these criteria will be chosen. It is also possible to define a mixture of environmentally friendly materials. If for example a material is needed having a first activity for a period of time and a second activity after the period of time lapsed, a combination of two materials can be suited to optimize the breaker profile.

It is also possible to define a process, by varying several criteria and comparing them. For the material used as breaker, the process comprises: (a) defining a rheology profile of the viscoelastic surfactant at a first given temperature; (b) defining a comparative rheology profile at the first given temperature of a composition of the viscoelastic surfactant and a first environmentally friendly component; (c) repeating step (b) with a second environmentally friendly component; (d) repeating steps (a) and (b) with a second given temperature and further step (c) with the second given temperature; and (e) defining between the first and second environmentally friendly components, environmentally friendly component showing optimum modification of the rheology based on analysis of the rheology profile and comparative rheology profile for the first and second temperatures.

The steps can be repeated for environmentally friendly components varying between first environmentally friendly component to n-th environmentally friendly component, and for temperatures varying between first temperature to m-th temperatures and defining between the first to n-th environmentally friendly components, environmentally friendly component showing optimum modification of the rheology based on analysis of the rheology profile and comparative rheology profiles between first temperature to m-th temperatures.

In this way, if a specific application is sought, it is possible for a panel of available environmentally friendly materials to find this one which will be the most suited. The specific application can be defined by various needed criteria including temperature. The criteria to look to choose the environmentally friendly material can be time to break of the viscoelastic surfactant, amount of decrease of the rheology, pH activity, salinity concentration, etc. . . . . Environmentally friendly material best suiting one or several of these criteria will be chosen. It is also possible to define a mixture of environmentally friendly materials. If for example a material is needed having a first activity for a period of time stable in a certain range of temperature and a second activity after the period of time lapsed in another range of temperature, a combination of two or more materials can be suited.

For the material used as defoamer, the process comprises: (a) defining a foaming property of the composition; (b) defining a comparative foaming property of the composition and a first environmentally friendly component (c) repeating step (b) with a second environmentally friendly component; (d) defining between the first and second environmentally friendly components, environmentally friendly component showing optimum defoaming property based on analysis of the foaming property and the comparative foaming property.

In one embodiment, the material is a nut. The nut is a general term for the large, dry, oily seeds or fruit of some plants. While a wide variety of dried seeds and fruits are called nuts, only a certain number of them are considered by biologists to be true nuts. In the foregoing document, we will consider the wide definition encompassing all sorts of nuts, and not only nuts from the biological definition.

The material can be a coconut. Although coconut contains less fat than other dry nuts such as almonds, it is noted for its high amount of saturated fat. Approximately 90% of the fat found in coconut is saturated. Coconut contains further dietary fibers. Chemically, dietary fiber consists of non-starch polysaccharides such as cellulose and many other plant components such as dextrins, inulin, lignin, waxes, chitins, pectins, beta-glucans and oligosaccharides. The term “fiber” is somewhat of a misnomer, since many types of so-called dietary fiber are not fibers at all.

The material can be nutmeg. Nutmeg is the seed of the Myristica fragrans evergreen tree indigenous to the Banda Islands in the Moluccas of Indonesia, or Spice Islands. Nutmeg is the source of nutmeg oil, which is used as a flavoring agent or spice in many culinary recipes and in pharmaceutical preparations. Major constituents of nutmeg oil are: myristicene, a fragrant eleopten, C₁₀H₁₄, myristicol a stearopten, or camphor, C₁₀H₁₆O, and myristin, chemical name: glyceryl trimyristate, C₃H₅(C₁₄H₂₇O₂)₃. Myristin is also found in spermaceti and many vegetable oils and fats, especially coconut oil.

The material can be hazelnut. Hazelnuts are rich in protein and unsaturated fat. Moreover, they contain significant amounts of thiamine and vitamin B6, as well as smaller amounts of other B vitamins. Additionally, 237 mL of hazelnut flour has 20 g of carbohydrates, 12 g of which are fibre. Hazelnut contains fats (primarily oleic acid), protein, carbohydrates, vitamins (vitamin E), minerals, diabetic fibres, phytosterol (beta-cytosterol) and antioxidant phenolics.

The material can be peanut. Peanut contains peanut oil. Its major component fatty acids are oleic acid (56.6%) and linoleic acid (26.7%). The oil also contains some palmitic acid, arachidic acid, arachidonic acid, behenic acid, lignoceric acid and other fatty acids. Peanut oil is a monounsaturated fat. The composition of the constituents may change from time to time and place to place. Also it may depend on the fertilizer used.

The material can be mustard. Mustard contains mustard oil which has about 60% monounsaturated fatty acids of which 42% erucic acid and 12% oleic acid, it has 21% polyunsaturates of which 6% is the omega-3 alpha-linolenic acid and 15% omega-6 linoleic acid and it has 12% saturated fats.

The material can be corn. Corn contains refined corn oil which is 99% triglyceride, with proportions of approximately 59% polyunsaturated fatty acid, 24% monounsaturated fatty acid, and 13% saturated fatty acid.

The material can be soybean. Together, oil and protein content account for about 60% of dry soybeans by weight; protein at 40% and oil at 20%. The remainder consists of 35% carbohydrate and about 5% ash. The major unsaturated fatty acids in soybean oil triglycerides are 7% linolenic acid (C-18:3); 51% linoleic acid (C-18:2); and 23% oleic acid (C-18:1). It also contains the saturated fatty acids 4% stearic acid and 10% palmitic acid.

The material can be palm. Palm contains palm oil and palm kernel oil which are composed of fatty acids, esterified with glycerol just like any ordinary fat. Both are high in saturated fatty acids, about 50% and 80%, respectively. The oil palm gives its name to the 16-carbon saturated fatty acid palmitic acid found in palm oil; monounsaturated oleic acid is also a constituent of palm oil while palm kernel oil contains mainly lauric acid.

The material can be rapeseed. Natural rapeseed oil contains 50% erucic acid. Wild type seeds also contain high levels of glucosinolates (mustard oil glucosindes). The material can be sunflower. Sunflower oil (linoleic sunflower oil) is high in polyunsaturated fatty acids (about 66% linoleic acid) and low in saturated fats, such as palmitic acid and stearic acid. The material can be rice bran. Rice bran oil contains a range of fats, with 47% of its fats monounsaturated, 33% polyunsaturated, and 20% saturated.

The material can be garlic powder. Garlic powder has garlic oil. Garlic is a “bulb”.

The material can be ginger. Ginger has ginger oil and can be used also (it is a root).

The material can be cinnamon. Cinnamon is from the “bark” of the tree.

The environmentally friendly material can be used as a breaker, a rheology modifier, a shear recovery or a defoamer/antifoam for a viscoelastic surfactant (VES) based fluids and other foams and energized fluids.

The VES may be selected from the group consisting of cationic, anionic, zwitterionic, amphoteric, nonionic and combinations thereof. Some non-limiting examples are those cited in U.S. Pat. Nos. 6,435,277 (Qu et al.) and 6,703,352 (Dahayanake et al.), each of which is incorporated herein by reference. The viscoelastic surfactants, when used alone or in combination, are capable of forming micelles that form a structure in an aqueous environment that contribute to the increased viscosity of the fluid (also referred to as “viscosifying micelles”). These fluids are normally prepared by mixing in appropriate amounts of VES suitable to achieve the desired viscosity. The viscosity of VES fluids may be attributed to the three dimensional structure formed by the components in the fluids. When the concentration of surfactants in a viscoelastic fluid significantly exceeds a critical concentration, and in many cases in the presence of an electrolyte, surfactant molecules aggregate into species such as micelles, which can interact to form a network exhibiting viscous and elastic behavior.

Non-limiting examples of suitable viscoelastic surfactants useful for viscosifying some fluids include cationic surfactants, anionic surfactants, zwitterionic surfactants, amphoteric surfactants, nonionic surfactants, and combinations thereof.

In general, particularly suitable zwitterionic surfactants have the formula:

RCONH—(CH₂)ₐ(CH₂CH₂O)ₘ(CH₂)_{b}—N⁺(CH₃)₂—(CH₂)ₐ.(CH₂CH₂O)ₘ.(CH₂)_{b}.COO⁻

in which R is an alkyl group that contains from about 11 to about 23 carbon atoms which may be branched or straight chained and which may be saturated or unsaturated; a, b, a′, and b′ are each from 0 to 10 and m and m′ are each from 0 to 13; a and b are each 1 or 2 if m is not 0 and (a+b) is from 2 to about 10 if m is 0; a′ and b′ are each 1 or 2 when m′ is not 0 and (a′+b′) is from 1 to about 5 if m is 0; (m+m′) is from 0 to about 14; and CH₂CH₂O may also be OCH₂CH₂.

In an embodiment of the invention, a zwitterionic surfactant of the family of betaine is used. Two suitable examples of betaines are BET-0 and BET-E. The surfactant in BET-O-30 is shown below; one chemical name is oleylamidopropyl betaine. It is designated BET-O-30 because as obtained from the supplier (Rhodia, Inc. Cranbury, N.J., U.S.A.) it is called Mirataine BET-O-30 because it contains an oleyl acid amide group (including a C₁₇H₃₃ alkene tail group) and contains about 30% active surfactant; the remainder is substantially water, sodium chloride, and propylene glycol. An analogous material, BET-E-40, is also available from Rhodia and contains an erucic acid amide group (including a C₂₁H₄₁ alkene tail group) and is approximately 40% active ingredient, with the remainder being substantially water, sodium chloride, and isopropanol. VES systems, in particular BET-E-40, optionally contain about 1% of a condensation product of a naphthalene sulfonic acid, for example sodium polynaphthalene sulfonate, as a rheology modifier, as described in U.S. Patent Application Publication No. 2003-0134751. The surfactant in BET-E-40 is also shown below; one chemical name is erucylamidopropyl betaine. As-received concentrates of BET-E-40 were used in the experiments reported below, where they will be referred to as “VES”. BET surfactants, and other VES's that are suitable for the invention, are described in U.S. Pat. No. 6,258,859. According to that patent, BET surfactants make viscoelastic gels when in the presence of certain organic acids, organic acid salts, or inorganic salts; in that patent, the inorganic salts were present at a weight concentration up to about 30%. Co-surfactants may be useful in extending the brine tolerance, and to increase the gel strength and to reduce the shear sensitivity of the VES-fluid, in particular for BET-O-type surfactants. An example given in U.S. Pat. No. 6,258,859 is sodium dodecylbenzene sulfonate (SDBS), also shown below. Other suitable co-surfactants include, for example those having the SDBS-like structure in which x=5-15; in some embodiments co-surfactants are those in which x=7-15. Still other suitable co-surfactants for BET-O-30 are certain chelating agents such as trisodium hydroxyethylethylenediamine triacetate. The rheology enhancers may be used with viscoelastic surfactant fluid systems that contain such additives as co-surfactants, organic acids, organic acid salts, and/or inorganic salts.

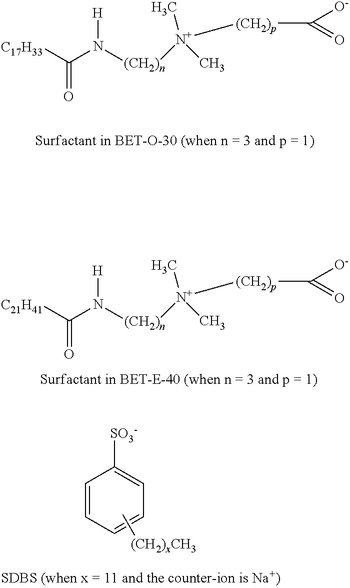

Some embodiments use betaines; for example BET-E-40. Although experiments have not been performed, it is believed that mixtures of betaines, especially BET-E-40, with other surfactants are also suitable. Such mixtures are within the scope of embodiments of the invention.

Other betaines that are suitable include those in which the alkene side chain (tail group) contains 17-23 carbon atoms (not counting the carbonyl carbon atom) which may be branched or straight chained and which may be saturated or unsaturated, n=2-10, and p=1-5, and mixtures of these compounds. In other embodiments, betaines are those in which the alkene side chain contains 17-21 carbon atoms (not counting the carbonyl carbon atom) which may be branched or straight chained and which may be saturated or unsaturated, n=3-5, and p=1-3, and mixtures of these compounds. These surfactants are used at a concentration of about 0.5 to about 10%, or from about 1 to about 5%, or from about 1.5 to about 4.5%.

Exemplary cationic viscoelastic surfactants include the amine salts and quaternary amine salts disclosed in U.S. Pat. Nos. 5,979,557, and 6,435,277 which have a common Assignee as the present application and which are hereby incorporated by reference. Examples of suitable cationic viscoelastic surfactants include cationic surfactants having the structure:

R₁N⁺(R₂)(R₃)(R₄)X⁻

in which R₁ has from about 14 to about 26 carbon atoms and may be branched or straight chained, aromatic, saturated or unsaturated, and may contain a carbonyl, an amide, a retroamide, an imide, a urea, or an amine; R₂, R₃, and R₄ are each independently hydrogen or a C₁ to about C₆ aliphatic group which may be the same or different, branched or straight chained, saturated or unsaturated and one or more than one of which may be substituted with a group that renders the R₂, R₃, and R₄ group more hydrophilic; the R₂, R₃ and R₄ groups may be incorporated into a heterocyclic 5- or 6-member ring structure which includes the nitrogen atom; the R₂, R₃ and R₄ groups may be the same or different; R₁, R₂, R₃ and/or R₄ may contain one or more ethylene oxide and/or propylene oxide units; and X⁻ is an anion. Mixtures of such compounds are also suitable. As a further example, R₁ is from about 18 to about 22 carbon atoms and may contain a carbonyl, an amide, or an amine, and R₂, R₃, and R₄ are the same as one another and contain from 1 to about 3 carbon atoms.

Cationic surfactants having the structure R₁N⁺(R₂)(R₃)(R₄) X⁻ may optionally contain amines having the structure R₁N(R₂)(R₃). It is well known that commercially available cationic quaternary amine surfactants often contain the corresponding amines (in which R₁, R₂, and R₃ in the cationic surfactant and in the amine have the same structure). As received commercially available VES surfactant concentrate formulations, for example cationic VES surfactant formulations, may also optionally contain one or more members of the group consisting of alcohols, glycols, organic salts, chelating agents, solvents, mutual solvents, organic acids, organic acid salts, inorganic salts, oligomers, polymers, co-polymers, and mixtures of these members. They may also contain performance enhancers, such as viscosity enhancers, for example polysulfonates, for example polysulfonic acids, as described in U.S. Pat. No. 7,084,095 which is hereby incorporated by reference.

Another suitable cationic VES is erucyl bis(2-hydroxyethyl)methyl ammonium chloride, also known as (Z)-13 docosenyl-N—N-bis(2-hydroxyethyl)methyl ammonium chloride. It is commonly obtained from manufacturers as a mixture containing about 60 weight percent surfactant in a mixture of isopropanol, ethylene glycol, and water. Other suitable amine salts and quaternary amine salts include (either alone or in combination in accordance with the invention), erucyl trimethyl ammonium chloride; N-methyl-N,N-bis(2-hydroxyethyl) rapeseed ammonium chloride; oleyl methyl bis(hydroxyethyl) ammonium chloride; erucylamidopropyltrimethylamine chloride, octadecyl methyl bis(hydroxyethyl) ammonium bromide; octadecyl tris(hydroxyethyl) ammonium bromide; octadecyl dimethyl hydroxyethyl ammonium bromide; cetyl dimethyl hydroxyethyl ammonium bromide; cetyl methyl bis(hydroxyethyl) ammonium salicylate; cetyl methyl bis(hydroxyethyl) ammonium 3,4,-dichlorobenzoate; cetyl tris(hydroxyethyl) ammonium iodide; cosyl dimethyl hydroxyethyl ammonium bromide; cosyl methyl bis(hydroxyethyl) ammonium chloride; cosyl tris(hydroxyethyl) ammonium bromide; dicosyl dimethyl hydroxyethyl ammonium bromide; dicosyl methyl bis(hydroxyethyl) ammonium chloride; dicosyl tris(hydroxyethyl) ammonium bromide; hexadecyl ethyl bis(hydroxyethyl) ammonium chloride; hexadecyl isopropyl bis(hydroxyethyl) ammonium iodide; and cetylamino, N-octadecyl pyridinium chloride.

Many fluids made with viscoelastic surfactant systems, for example those containing cationic surfactants having structures similar to that of erucyl bis(2-hydroxyethyl)methyl ammonium chloride, inherently have short re-heal times and the rheology enhancers may not be needed except under special circumstances, for example at very low temperature.

Amphoteric viscoelastic surfactants are also suitable. Exemplary amphoteric viscoelastic surfactant systems include those described in U.S. Pat. No. 6,703,352, for example amine oxides. Other exemplary viscoelastic surfactant systems include those described in U.S. Pat. Nos. 6,239,183; 6,506,710; 7,060,661; 7,303,018; and 7,510,009 for example amidoamine oxides. These references are hereby incorporated in their entirety. Mixtures of zwitterionic surfactants and amphoteric surfactants are suitable. An example is a mixture of about 13% isopropanol, about 5% 1-butanol, about 15% ethylene glycol monobutyl ether, about 4% sodium chloride, about 30% water, about 30% cocoamidopropyl betaine, and about 2% cocoamidopropylamine oxide.

The viscoelastic surfactant system may also be based upon any suitable anionic surfactant. In some embodiments, the anionic surfactant is an alkyl sarcosinate. The alkyl sarcosinate can generally have any number of carbon atoms. In some embodiments, alkyl sarcosinates have about 12 to about 24 carbon atoms. The alkyl sarcosinate can have about 14 to about 18 carbon atoms. Specific examples of the number of carbon atoms include 12, 14, 16, 18, 20, 22, and 24 carbon atoms. The anionic surfactant is represented by the chemical formula:

R₁CON(R₂)CH₂X

wherein R₁ is a hydrophobic chain having about 12 to about 24 carbon atoms, R₂ is hydrogen, methyl, ethyl, propyl, or butyl, and X is carboxyl or sulfonyl. The hydrophobic chain can be an alkyl group, an alkenyl group, an alkylarylalkyl group, or an alkoxyalkyl group. Specific examples of the hydrophobic chain include a tetradecyl group, a hexadecyl group, an octadecentyl group, an octadecyl group, and a docosenoic group.

To provide the ionic strength for the desired micelle formation, the VES may further comprise a water-soluble salt. Adding a salt may promote micelle, lamellar or vesicle formation for the viscosification of the fluid. In some embodiments, the aqueous base fluid may contain the water-soluble salt, for example, where saltwater, a brine, or seawater is used as the aqueous base fluid. Suitable water-soluble salts may comprise lithium, ammonium, sodium, potassium, cesium, magnesium, calcium, or zinc cations, and chloride, bromide, iodide, formate, nitrate, acetate, cyanate, or thiocyanate anions. Examples of suitable water-soluble salts that comprise the above-listed anions and cations include, but are not limited to, ammonium chloride, lithium bromide, lithium chloride, lithium formate, lithium nitrate, calcium bromide, calcium chloride, calcium nitrate, calcium formate, sodium bromide, sodium chloride, sodium formate, sodium nitrate, potassium chloride, potassium bromide, potassium nitrate, potassium formate, cesium nitrate, cesium formate, cesium chloride, cesium bromide, magnesium chloride, magnesium bromide, zinc chloride, and zinc bromide. In certain embodiments, the water-soluble salt may be present in the fluid in an amount in the range of from about 0.1% to about 40% by weight. In certain other embodiments, the water-soluble salt may be present in the fluid in an amount in the range of from about 1% to about 10% by weight.

The environmentally friendly material can be used as a defoamer/antifoam for a polymer or a crosslinked polymer viscosifier.

The crosslinked polymer can generally be any crosslinked polymers. The polymer viscosifier can be a metal-crosslinked polymer. Suitable polymers for making the metal-crosslinked polymer viscosifiers include, for example, polysaccharides such as substituted galactomannans, such as guar gums, high-molecular weight polysaccharides composed of mannose and galactose sugars, or guar derivatives such as hydroxypropyl guar (HPG), carboxymethylhydroxypropyl guar (CMHPG) and carboxymethyl guar (CMG), hydrophobically modified guars, guar-containing compounds, and synthetic polymers. Crosslinking agents based on boron, titanium, zirconium or aluminum complexes are typically used to increase the effective molecular weight of the polymer and make them better suited for use in high-temperature wells.

Other suitable classes of polymers effective as viscosifiers include polyvinyl polymers, polymethacrylamides, cellulose ethers, lignosulfonates, and ammonium, alkali metal, and alkaline earth salts thereof. More specific examples of other typical water soluble polymers are acrylic acid-acrylamide copolymers, acrylic acid-methacrylamide copolymers, polyacrylamides, partially hydrolyzed polyacrylamides, partially hydrolyzed polymethacrylamides, polyvinyl alcohol, polyalkyleneoxides, other galactomannans, heteropolysaccharides obtained by the fermentation of starch-derived sugar and ammonium and alkali metal salts thereof.

Cellulose derivatives are used to a smaller extent, such as hydroxyethylcellulose (HEC) or hydroxypropylcellulose (HPC), carboxymethylhydroxyethylcellulose (CMHEC) and carboxymethycellulose (CMC), with or without crosslinkers. Xanthan, diutan, and scleroglucan, three biopolymers, have been shown to have excellent proppant-suspension ability even though they are more expensive than guar derivatives and therefore have been used less frequently, unless they can be used at lower concentrations.

In other embodiments, the crosslinked polymer is made from a crosslinkable, hydratable polymer and a delayed crosslinking agent, wherein the crosslinking agent comprises a complex comprising a metal and a first ligand selected from the group consisting of amino acids, phosphono acids, and salts or derivatives thereof. Also the crosslinked polymercan be made from a polymer comprising pendant ionic moieties, a surfactant comprising oppositely charged moieties, a clay stabilizer, a borate source, and a metal crosslinker. Said embodiments are described in U.S. Patent Publications US2008-0280790 and US2008-0280788 respectively, each of which are incorporated herein by reference.

Linear (not cross-linked) polymer systems may be used. Any suitable crosslinked polymer system may be used, including for example, those which are delayed, optimized for high temperature, optimized for use with sea water, buffered at various pH's, and optimized for low temperature. Any crosslinker may be used, for example boron, titanium, zirconium, aluminum and the like. Suitable boron crosslinked polymers systems include by non-limiting example, guar and substituted guars crosslinked with boric acid, sodium tetraborate, and encapsulated borates; borate crosslinkers may be used with buffers and pH control agents such as sodium hydroxide, magnesium oxide, sodium sesquicarbonate, and sodium carbonate, amines (such as hydroxyalkyl amines, anilines, pyridines, pyrimidines, quinolines, and pyrrolidines, and carboxylates such as acetates and oxalates) and with delay agents such as sorbitol, aldehydes, and sodium gluconate. Suitable zirconium crosslinked polymer systems include by non-limiting example, those crosslinked by zirconium lactates (for example sodium zirconium lactate), triethanolamines, 2,2′-iminodiethanol, and with mixtures of these ligands, including when adjusted with bicarbonate. Suitable titanates include by non-limiting example, lactates and triethanolamines, and mixtures, for example delayed with hydroxyacetic acid. Any other chemical additives may be used or included provided that they are tested for compatibility with the viscoelastic surfactant. For example, some of the standard crosslinkers or polymers as concentrates usually contain materials such as isopropanol, n-propanol, methanol or diesel oil.

The environmentally friendly material can be used as a defoamer/antifoam for cementing materials.

The cementing material can be based on Portland cements in classes A, B, C, G and R as defined in Section 10 of the American Petroleum Institute's (API) standards. Classes G and H Portland cements can also be used as well as other cements which are known in this art. For low-temperature applications, aluminous cements and Portland/plaster mixtures (e.g. for deepwater wells) or cement/silica mixtures (e.g. for wells where the temperature exceeds 120° C.) can be used, or cements obtained by mixing a Portland cement, slurry cements and/or fly ash.

When the material is used as a breaker in VES, the fluid may further comprise proppant materials. The selection of a proppant involves many compromises imposed by economical and practical considerations. Criteria for selecting the proppant type, size, and concentration is based on the needed dimensionless conductivity, and can be selected by a skilled artisan. Such proppants can be natural or synthetic (including but not limited to glass beads, ceramic beads, sand, and bauxite), coated, or contain chemicals; more than one can be used sequentially or in mixtures of different sizes or different materials. The proppant may be resin coated, or pre-cured resin coated, provided that the resin and any other chemicals that might be released from the coating or come in contact with the other chemicals are compatible with them. Proppants and gravels in the same or different wells or treatments can be the same material and/or the same size as one another and the term “proppant” is intended to include gravel in this discussion. In general the proppant used will have an average particle size of from about 0.15 mm to about 2.39 mm (about 8 to about 100 U.S. mesh), more particularly, but not limited to 0.25 to 0.43 mm (40/60 mesh), 0.43 to 0.84 mm (20/40 mesh), 0.84 to 1.19 mm (16/20), 0.84 to 1.68 mm (12/20 mesh) and 0.84 to 2.39 mm (8/20 mesh) sized materials. Normally the proppant will be present in the slurry in a concentration of from about 0.12 to about 0.96 kg/L, or from about 0.12 to about 0.72 kg/L, or from about 0.12 to about 0.54 kg/L. The fluid may also contain other enhancers or additives.

According to the invention, the environmentally friendly material may be used for carrying out a variety of subterranean treatments, where (a) a viscosified treatment fluid may be used, including, but not limited to, drilling operations, fracturing treatments, and completion operations (e.g., gravel packing), or (b) a treatment fluid may be used which does not contain foam, including, but not limited to, drilling operations, fracturing treatments, and completion operations (e.g., gravel packing, primary cementing, squeeze or remedial cementing). In some embodiments, the treatment fluids may be used in treating a portion of a subterranean formation. In certain embodiments, the composition may be introduced into a well bore that penetrates the subterranean formation. Optionally, the treatment fluid further may comprise particulates and other additives suitable for treating the subterranean formation. For example, the treatment fluid may be allowed to contact the subterranean formation for a period of time sufficient to reduce the viscosity of the treatment fluid. In some embodiments, the treatment fluid may be allowed to contact hydrocarbons, formations fluids, and/or subsequently injected treatment fluids, thereby reducing the viscosity of the treatment fluid. After a chosen time, the treatment fluid may be recovered through the well bore.

According to the invention, the optimization process may be used for carrying out a variety of subterranean treatments applications, where (a) a viscosified treatment fluid may be used, including, but not limited to, drilling operations, fracturing treatments, and completion operations (e.g., gravel packing), or (b) a treatment fluid may be used which does not contain foam, including, but not limited to, drilling operations, fracturing treatments, and completion operations (e.g., gravel packing, primary cementing, squeeze or remedial cementing). In some embodiments, the treatment fluids may be used in treating a portion of a subterranean formation. In certain embodiments, the composition may be introduced into a well bore that penetrates the subterranean formation. Optionally, the treatment fluid further may comprise particulates and other additives suitable for treating the subterranean formation. For example, the treatment fluid may be allowed to contact the subterranean formation for a period of time sufficient to reduce the viscosity of the treatment fluid. In some embodiments, the treatment fluid may be allowed to contact hydrocarbons, formations fluids, and/or subsequently injected treatment fluids, thereby reducing the viscosity of the treatment fluid. After a chosen time, the treatment fluid may be recovered through the well bore.

In certain embodiments, the treatment fluids may be used in fracturing treatments. In the fracturing embodiments, the composition may be introduced into a well bore that penetrates a subterranean formation at or above a pressure sufficient to create or enhance one or more fractures in a portion of the subterranean formation. Generally, in the fracturing embodiments, the composition may exhibit viscoelastic behavior which may be due. Optionally, the treatment fluid further may comprise particulates and other additives suitable for the fracturing treatment. After a chosen time, the treatment fluid may be recovered through the well bore.

The compositions and methods of the invention are compatible with conventional breakers of the prior art. It is possible for example, to use a soluble or encapsulated breaker in the pad in earlier stages followed by an environmentally friendly component e.g. coconut. Also, e.g. a coconut stage can be followed by an oxidizer stage.

The method of the invention is also suitable for gravel packing, or for fracturing and gravel packing in one operation (called, for example frac and pack, frac-n-pack, frac-pack, StimPac treatments, or other names), which are also used extensively to stimulate the production of hydrocarbons, water and other fluids from subterranean formations. These operations involve pumping a slurry of “proppant” (natural or synthetic materials that prop open a fracture after it is created) in hydraulic fracturing or “gravel” in gravel packing. In low permeability formations, the goal of hydraulic fracturing is generally to form long, high surface area fractures that greatly increase the magnitude of the pathway of fluid flow from the formation to the wellbore. In high permeability formations, the goal of a hydraulic fracturing treatment is typically to create a short, wide, highly conductive fracture, in order to bypass near-wellbore damage done in drilling and/or completion, to ensure good fluid communication between the rock and the wellbore and also to increase the surface area available for fluids to flow into the wellbore.

Gravel is also a natural or synthetic material, which may be identical to, or different from, proppant. Gravel packing is used for “sand” control. Sand is the name given to any particulate material from the formation, such as clays, that could be carried into production equipment. Gravel packing is a sand-control method used to prevent production of formation sand, in which, for example a steel screen is placed in the wellbore and the surrounding annulus is packed with prepared gravel of a specific size designed to prevent the passage of formation sand that could foul subterranean or surface equipment and reduce flows. The primary objective of gravel packing is to stabilize the formation while causing minimal impairment to well productivity. Sometimes gravel packing is done without a screen. High permeability formations are frequently poorly consolidated, so that sand control is needed; they may also be damaged, so that fracturing is also needed. Therefore, hydraulic fracturing treatments in which short, wide fractures are wanted are often combined in a single continuous (“frac and pack”) operation with gravel packing. For simplicity, in the following we may refer to any one of hydraulic fracturing, fracturing and gravel packing in one operation (frac and pack), or gravel packing, and mean them all.

To facilitate a better understanding of the invention, the following examples of embodiments are given. In no way should the following examples be read to limit, or define, the scope of the invention.

### EXAMPLES

Some tests were conducted to show the properties of the environmentally friendly material to act as a breaker and possibility to optimize the breaker depending on the applications. The VES fluids for all experiments described below employed a betaine surfactant BET-E-40, which was provided by Rhodia, Inc. Cranbury, N.J. BET-E-40 contains approximately 38 wt % of erucic amidopropyl dimethyl betaine as active ingredient. The coconut, mustard, cinnamon, and nutmeg powders were purchased from a local grocery store in Texas.

Fluid viscosities were measured as a function of time and temperature on Chandler viscometers. A standard procedure was applied, where the viscosity was measured at a shear rate of 100 s⁻¹ with ramps down to 75 s⁻¹, 50 s⁻¹ and 25 s⁻¹ every 30 minutes.

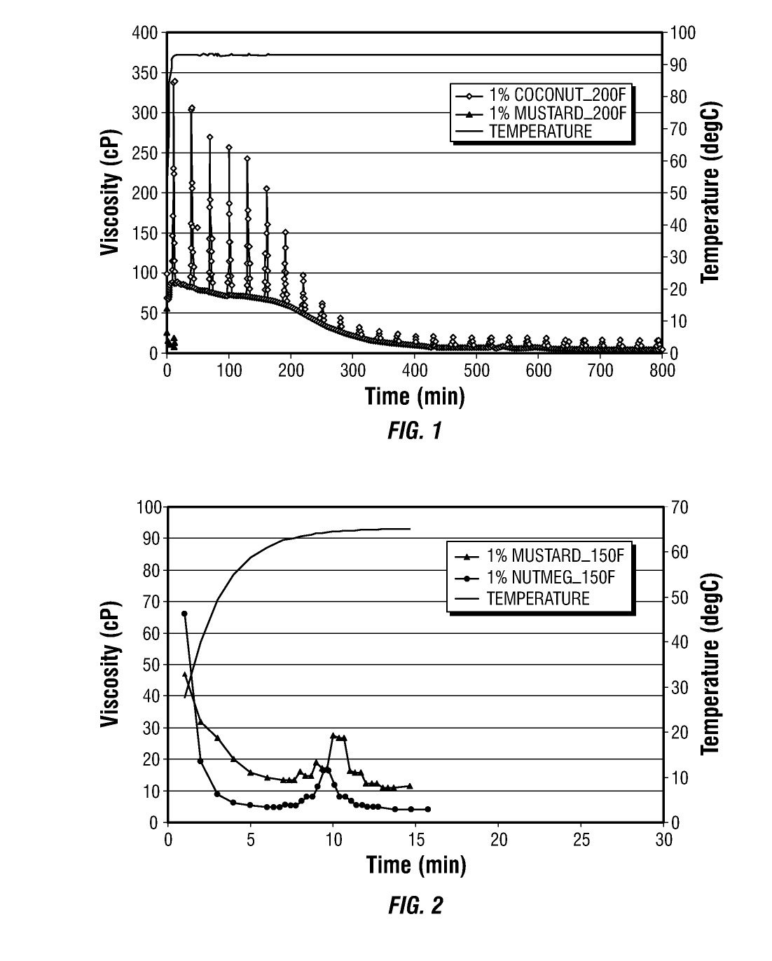

It was found during these tests that various additives used in the food industry can act as excellent breakers for VES fluids. For example, FIG. 1 shows that both coconut powder and mustard reduce the fluid viscosity substantially with coconut offering a well controlled time at the used loading (1 wt %). Nutmeg powder behaved similarly to mustard, and gave a faster break when compared to coconut powder. This suggests that the breaking profile can be tailored by choosing different breakers. Parallel bottle tests conducted in an oven also confirmed that the fluids indeed were broken by these powders. Furthermore, the fluids did not re-viscosify after cool-down, suggesting permanent breaking, unlike some of the breakers commercially available foe Viscoelastic surfactant fluids.

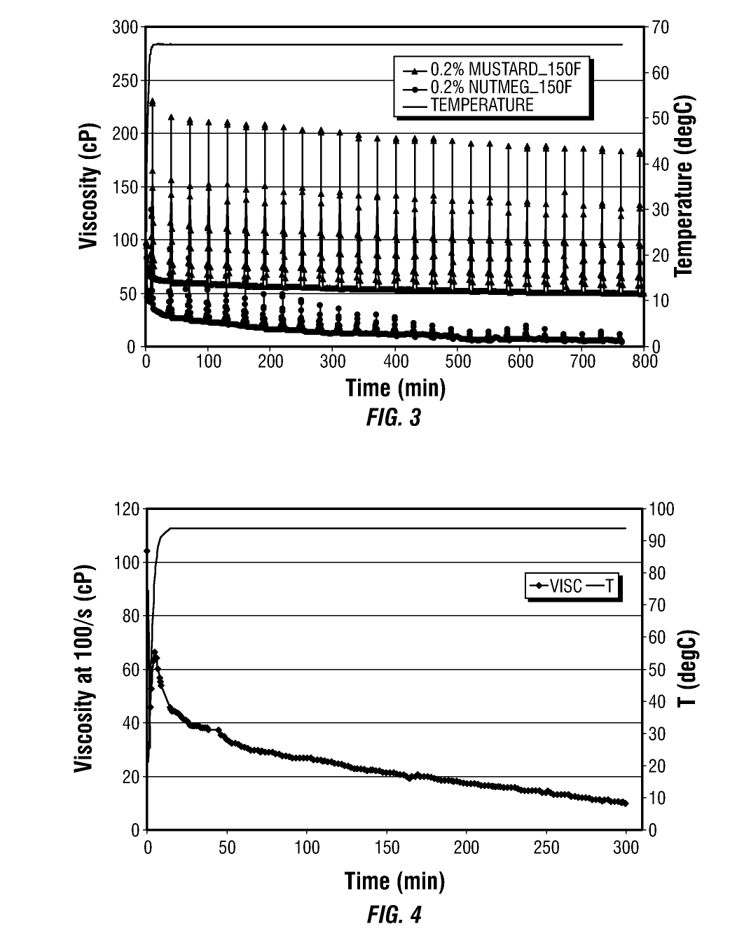

FIG. 2 indicates that the fast breaking of mustard and nutmeg powders continues at lower temperatures such as 150 degF (65.6 degC). But a more delayed viscosity reduction can be achieved by reducing the powder concentration such as to 0.25 wt % shown on FIG. 3. Therefore, the break profile not only can be adjusted by using different breakers, but can also be realized by varying the concentrations. These materials can give time/Temperature delayed controllable break for the VES systems.

In addition to being breakers for VES fluids, these powders can also be used for fluid loss control applications particularly for VES and polymer fluids treatments. These powders can initially be incorporated in the fluids in the pad and/or also in the slurry stages to provide fluid loss control during the job. These solid materials can release the active ingredient and break the fluid for improved cleanup. Once the treatment is over, the powders then start to break the fluid for improved clean-up.

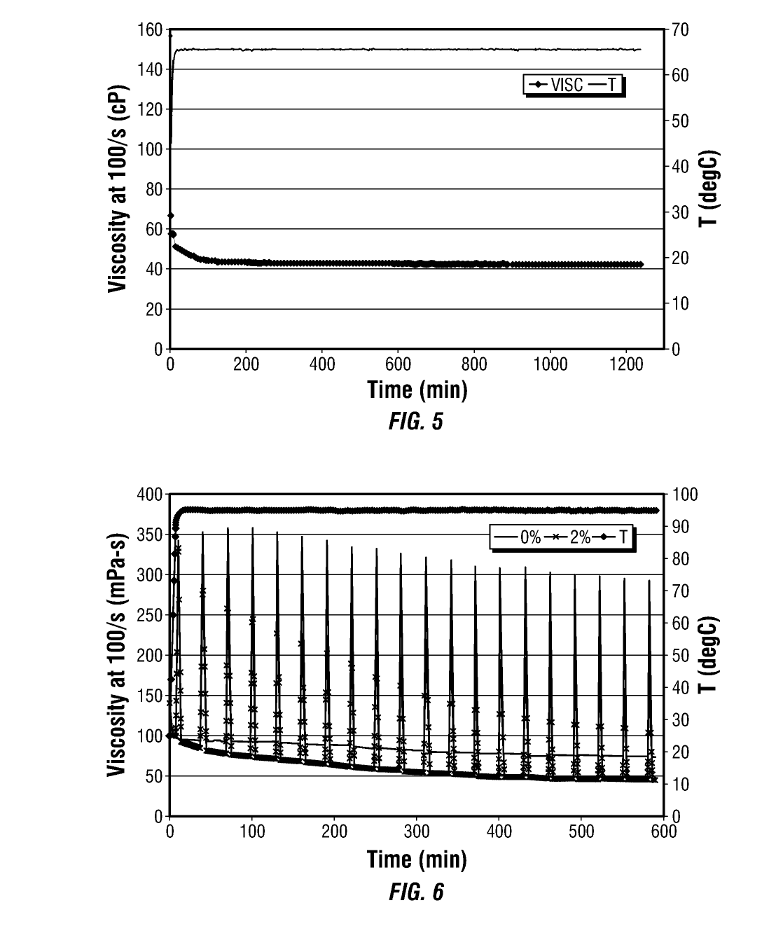

FIGS. 4 and 5 give an example of using cinnamon as breaker for VES fluids. The formulation used was 6% BET-E-40, 2% KCl, and 1% cinnamon. In FIG. 4, it can be seen that the viscosity gradually decreases with time, indicating that cinnamon acting as a breaker for the VES fluid. At lower temperatures such as at 150 degF (65.6 degC) shown in FIG. 5, the breaking is slowed down significantly, with minimal change at temperature although there was some initial viscosity reduction once the cinnamon was added.

FIG. 6 shows viscosity as a function of time for a VES fluid containing 6 vol % BET-E-40 and 0% or 2% coconut powder at 200° F. (93° C.) in CaCl₂ brine solution. The coconut powder is an efficient breaker for VES in high density brine. As shown, the coconut powder lowers the viscosity to less than half in 6 hours. Nutmeg or mustard powders can be used for faster break when necessary.

Some further tests were conducted to show the properties of the environmentally friendly material to act as a defoamer/antifoamer.

In this study foams made from surfactants, VES, polymers and cement systems were used. The coconut, mustard, and nutmeg powders were purchased from a local grocery store in Texas.

Coconut, mustard, and nutmeg powders were tested as potential defoamers. Benchtop experiments of foam height and half-life were performed to evaluate their performance. Briefly, 100 mL of test fluid was poured into a Waring blender cup and mixed for 3 minutes with variable transformer set on low (10-20% power) so as not to generate foam. The solution was then stirred for exactly 30 seconds at the low speed setting with 100% power, and the resulting foam was immediately transferred into a 500 mL graduated cylinder. The initial foam volume in mL was recorded as foam height. The time required, less 30 seconds, for 50 mL of water breakout is recorded as the foam half-life. All experiments described in this study were conducted at ambient conditions. In general, good foam height and long half-life indicate that the foamability of the fluid and its stability. FIG. 1 shows that foam height of the fluid is significantly reduced by 50% with the addition of any of the three powders. A great reduction is also seen for the foam half-life as illustrated in FIG. 2. Thus these powders are demonstrated to act as good defoamers where such applications are desired, for example, handling of foamed fluids on surface. These can also be used to eliminate the issues with foaming in production lines.

Some further tests were conducted to show example of an optimization process of the environmentally friendly material acting as a breaker.

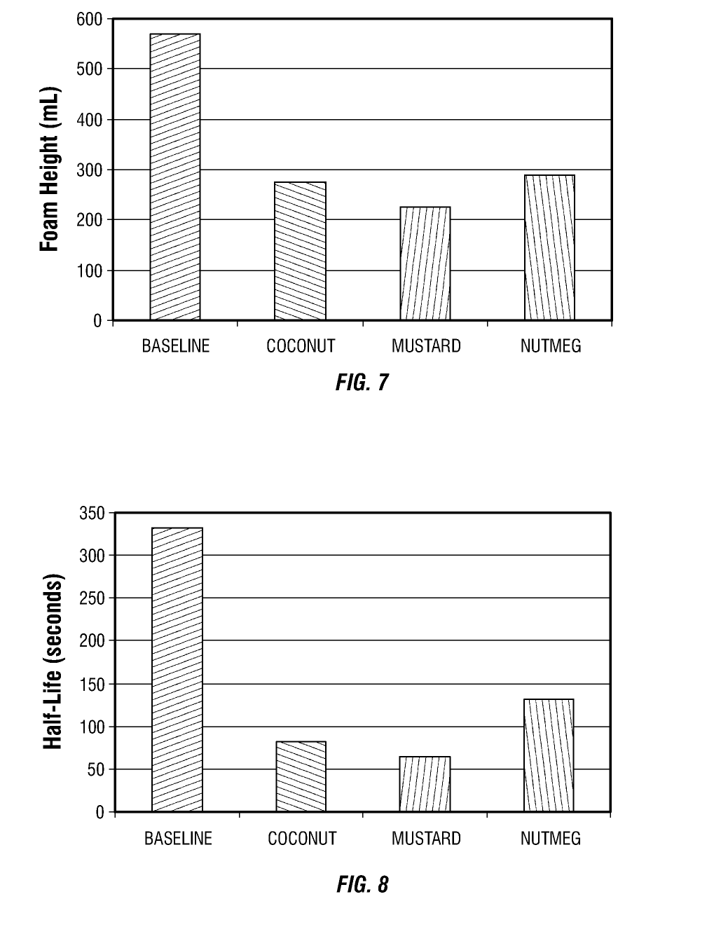

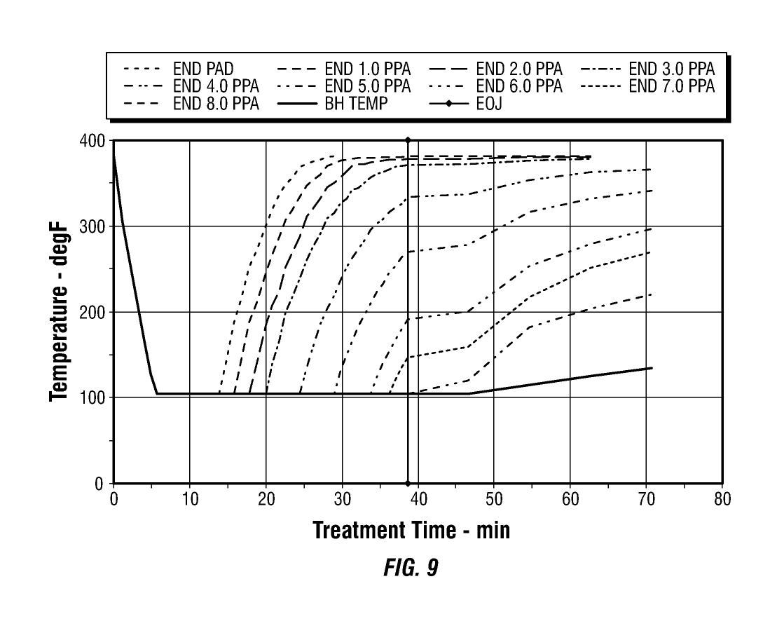

FIG. 9 shows optimization process of the environmentally friendly breaker made with a fracturing job simulation software. The breaker schedule test was performed at the estimate bottom hole temperature of the well (BHST). The Stage Temperature Tracking plot shows the temperature profiles and residence time for all the stages of the treatment schedule. The residence time is the time at the end of the job, EOJ minus the time at which a stage enters in the fracture. However, to be more conservative, this resident time was extended until time at the end of the closure. By analyzing the Stage Temperature Tracking as shown in FIG. 7, the breaker schedule can be designed as shown below in Table 1. Cinnamon, which is a HT breaker, can be used in the beginning stages of the treatment. This will be followed by coconut as shown below in Table 1. To get a clean and complete break of the viscosity, 10 lb of nutmeg powder is used at the last stage of the treatment.

TABLE 1

| | | | Cinnamon | | Coconut | | | |
|---|---|---|---|---|---|---|---|---|
| | | | Stage | | Stage | Stage | Cum | Time |
| Stage | Volume | Cinnamon | Quantity | Coconut | Quantity | Time | Time | Remaining |
| Name | gallons | lb/mgal | (lb) | lbs/Mgal | (lb) | (min) | (min) | (min) |
| PAD | 28571 | 3.0 | 86 | 0.0 | 0.0 | 22.7 | 23 | 47 |
| 1.0 | 4762 | 5.0 | 24 | 3.0 | 14.3 | 3.8 | 26 | 43 |
| PPA | | | | | | | | |
| 2.0 | 4762 | 5.0 | 24 | 3.0 | 14.3 | 3.8 | 30 | 39 |
| PPA | | | | | | | | |
| 3.0 | 7143 | 10.0 | 71 | 5.0 | 35.7 | 5.7 | 36 | 34 |
| PPA | | | | | | | | |
| 4.0 | 7143 | 10.0 | 71 | 5.0 | 35.7 | 5.7 | 42 | 28 |
| PPA | | | | | | | | |
| 5.0 | 7143 | 0.0 | 0 | 10.0 | 71.4 | 5.7 | 47 | 22 |
| PPA | | | | | | | | |
| 6.0 | 7143 | 0.0 | 0 | 10.0 | 71.4 | 5.7 | 53 | 17 |
| PPA | | | | | | | | |
| 7.0 | 7143 | 0.0 | 0 | 10.0 | 71.4 | 5.7 | 59 | 11 |
| PPA | | | | | | | | |
| 8.0 | 7143 | 0.0 | 0 | 10.0 | 71 | 5.7 | 64 | 5 |
| PPA | | | | | | | | |
| FLUSH | 6681 | 0.0 | 0 | 5.0 | 33 | 5.3 | 70 | 0 |

The foregoing disclosure and description of the invention is illustrative and explanatory thereof and it can be readily appreciated by those skilled in the art that various changes in the size, shape and materials, as well as in the details of the illustrated construction or combinations of the elements described herein can be made without departing from the spirit of the invention.

What is claimed is:

1. A well treatment composition comprising: a viscoelastic surfactant and an environmentally friendly component made of cellulosic matrix with organic acid derivative trapped within.

2. The composition of claim 1, wherein the component is encapsulated.

3. The composition of claim 1, wherein the component is a breaker.

4. The composition of claim 3, wherein the breaker is encapsulated.

5. The composition of claim 1, wherein the component is selected from the group consisting of: coconut, mustard, nutmeg, peanut, sesame, canola, cashew nut, corn, neetsfoot, almond, cottonseed, palm, walnut, caster seed, perilla, beech nut, lard, rice bran, pistachios, linseed, sunflower seed, hazelnut, squash seed, safflower, kola nut, rapeseed, sardine, brazilnut, candlenut, chilly seed, chestnut, acorn, soybean, macademia, coco, coffee bean, pinenut, butternut, pumpkin, hickory, dees nuts, olive, filbert, pecan, cacao, garlic powder, ginger, cinnamon, and combinations thereof.

6. A well treatment composition comprising: a cementing composition and an environmentally friendly defoamer made of cellulosic matrix with organic acid derivative trapped within.

7. The composition of claim 4, wherein the component is selected from the group consisting of: coconut, mustard, nutmeg, peanut, sesame, canola, cashew nut, corn, neetsfoot, almond, cottonseed, palm, walnut, caster seed, perilla, beech nut, lard, rice bran, pistachios, linseed, sunflower seed, hazelnut, squash seed, safflower, kola nut, rapeseed, sardine, brazilnut, candlenut, chilly seed, chestnut, acorn, soybean, macademia, coco, coffee bean, pinenut, butternut, pumpkin, hickory, dees nuts, olive, filbert, pecan, cacao, garlic powder, ginger, cinnamon, and combinations thereof.

8. A method comprising:
introducing into a wellbore penetrating a subterranean formation an environmentally friendly component made of cellulosic matrix with organic acid derivative trapped within.

9. The method of claim 8, wherein the component is encapsulated.

10. The method of claim 8, further comprising the step of introducing into the wellbore a viscoelastic surfactant.

11. The method of claim 10, further comprising introducing into the wellbore penetrating the subterranean formation a breaker which is not an environmentally friendly component.

12. The method of claim 11, wherein the breaker is an oxidizer, an enzyme.

13. The method of claim 12, wherein the breaker is encapsulated.

14. The method of claim 8, further comprising the step of introducing into the wellbore a cementing composition.

15. The method of claim 6, wherein the component is selected from the group consisting of: coconut, mustard, nutmeg, peanut, sesame, canola, cashew nut, corn, neetsfoot, almond, cottonseed, palm, walnut, caster seed, perilla, beech nut, lard, rice bran, pistachios, linseed, sunflower seed, hazelnut, squash seed, safflower, kola nut, rapeseed, sardine, brazilnut, candlenut, chilly seed, chestnut, acorn, soybean, macademia, coco, coffee bean, pinenut, butternut, pumpkin, hickory, dees nuts, olive, filbert, pecan, cacao, garlic powder, ginger, cinnamon, and combinations thereof.

16. A method for rheology modification optimization of a viscoelastic surfactant fluid, comprising:
(a) defining a rheology profile of the viscoelastic surfactant fluid;
(b) defining a comparative rheology profile of a composition of the viscoelastic surfactant fluid and a first environmentally friendly component made of cellulosic matrix with organic acid derivative trapped within;
(c) repeating step (b) with a second environmentally friendly component made of cellulosic matrix with organic acid derivative trapped within;
(d) defining between the first and second environmentally friendly components, environmentally friendly component showing optimum modification of the rheology based on analysis of the rheology profile and comparative rheology profile.

17. The method of claim 16, further comprising defining integer number n, wherein the steps are repeated for environmentally friendly components varying between first environmentally friendly component to n-th environmentally friendly component, wherein the environmentally friendly components are made of cellulosic matrix with organic acid derivative trapped within and defining between the first to n-th environmentally friendly components, environmentally friendly component showing optimum modification of the rheology based on analysis of the rheology profile and comparative rheology profiles.

18. The method of claim 16, wherein the environmentally friendly components are selected from the group consisting of: coconut, mustard, nutmeg, peanut, sesame, canola, cashew nut, corn, neetsfoot, almond, cottonseed, palm, walnut, caster seed, perilla, beech nut, lard, rice bran, pistachios, linseed, sunflower seed, hazelnut, squash seed, safflower, kola nut, rapeseed, sardine, brazilnut, candlenut, chilly seed, chestnut, acorn, soybean, macademia, coco, coffee bean, pinenut, butternut, pumpkin, hickory, dees nuts, olive, filbert, pecan, cacao, garlic powder, ginger, cinnamon, and combinations thereof.

19. A method for rheology modification optimization of a viscoelastic surfactant, comprising:
(a) defining a rheology profile of the viscoelastic surfactant at a first given temperature;
(b) defining a comparative rheology profile at the first given temperature of a composition of the viscoelastic surfactant and a first environmentally friendly component made of cellulosic matrix with organic acid derivative trapped within;
(c) repeating step (b) with a second environmentally friendly component made of cellulosic matrix with organic acid derivative trapped within;
(d) repeating steps (a) and (b) with a second given temperature and further step (c) with said second given temperature; and
(e) defining between the first and second environmentally friendly components, environmentally friendly component showing optimum modification of the rheology based on analysis of the rheology profile and comparative rheology profile for the first and second temperatures.

20. The method of claim 19, further comprising defining integer numbers n and m, wherein the steps are repeated for environmentally friendly components varying between first environmentally friendly component to n-th environmentally friendly component; and for temperatures varying between first temperature to m-th temperature, wherein the environmentally friendly components are made of cellulosic matrix with organic acid derivative trapped within and defining between the first to n-th environmentally friendly components, environmentally friendly component showing optimum modification of the rheology based on analysis of the rheology profile and comparative rheology profiles for the first to m-th temperatures.

21. The method of claim 19, wherein the environmentally friendly components are selected from the group consisting of: coconut, mustard, nutmeg, peanut, sesame, canola, cashew nut, corn, neetsfoot, almond, cottonseed, palm, walnut, caster seed, perilla, beech nut, lard, rice bran, pistachios, linseed, sunflower seed, hazelnut, squash seed, safflower, kola nut, rapeseed, sardine, brazilnut, candlenut, chilly seed, chestnut, acorn, soybean, macademia, coco, coffee bean, pinenut, butternut, pumpkin, hickory, dees nuts, olive, filbert, pecan, cacao, garlic powder, ginger, cinnamon, and combinations thereof.

22. A method for defoaming optimization of a composition, comprising:
(a) defining a foaming property of the composition;
(b) defining a comparative foaming property of the composition and a first environmentally friendly component made of cellulosic matrix with organic acid derivative trapped within;
(c) repeating step (b) with a second environmentally friendly component made of cellulosic matrix with organic acid trapped within;
(d) defining between the first and second environmentally friendly components, environmentally friendly component showing optimum defoaming property based on analysis of the foaming property and the comparative foaming property.
